(19) United States
(12) Patent Application Publication
(10) Pub. No.: US 2011/0227868 A1
(43) Pub. Date: Sep. 22, 2011

(54) PROXIMITY-SENSING PANEL

(75) Inventors: Yi-Ta Chen, Taoyuan County (TW); Jun-Hua Yeh, Taoyuan County (TW)

(73) Assignee: Edamak Corporation, Taoyuan County (TW)

(21) Appl. No.: 13/050,080

(22) Filed: Mar. 17, 2011

(30) Foreign Application Priority Data
Mar. 17, 2010 (TW) 099107874
Sep. 3, 2010 (TW) 099129860
Feb. 16, 2011 (TW) 100105121

(51) Int. Cl. G06F 3/045

(52) U.S. Cl. 345/174; 345/173

(57) ABSTRACT

A proximity-sensing panel includes a substrate panel, one or more proximity-sensing unit and one or more sensing circuit. The proximity-sensing unit is formed on the substrate panel. The proximity-sensing unit senses motions of an object to generate a proximity-sensing signal accordingly. The sensing circuit receives the proximity-sensing signal and generates a control signal to initiate a proximity touch control.

### CROSS-REFERENCES TO RELATED APPLICATIONS

This non-provisional application claims priority under 35 U.S.C. §119(a) on Patent Application No. 99107874, 99129860, and 100105121 filed in Taiwan, R.O.C. on 2010 Mar. 17, 2010 Sep. 3 and 2011 Feb. 16 the entire contents of which are hereby incorporated by reference.

### BACKGROUND OF THE INVENTION

1. Field of Invention

The present invention relates to a panel and in particular to a proximity-sensing panel.

2. Related Art

Accompanying with developments of optoelectronics technology, proximity switching device has been massively applied to various machines, e.g. smart phone, transportation ticketing system, digital camera, remote control, liquid crystal display (LCD) and etc. A common proximity switching device includes a proximity sensor and a touch panel, which is mainly used to switch the system status.

Please refer to FIG. 1, which is a system block diagram of an inductive proximity-sensing system 100. The inductive proximity-sensing system 100 includes an object 10, a proximity-sensing unit 101, a sensing circuit 105 and a microcontroller 106. When the object 10 is approaching close to the proximity-sensing unit 101, the capacitance sensed by the proximity-sensing unit 101 varies according to the distance of the object 10. Meanwhile, an oscillation signal is generated from the oscillator 102 according the generated oscillation frequency/amplitude that varies on different distances of the object 10. The detection circuit 103 converts the oscillation signal into a fixed direct-current voltage and send to the output circuit 104. The output circuit 104 is adapted to receive the fixed direct-current voltage, increase the driving power and then send as an output signal to the microcontroller 106 or a controlled load terminal.

Generally touch panel includes resistive type, Surface Capacitive type, Projected Capacitive type, infrared type, sound wave type, optical type, magnetic sensing type and digital type. Refer to FIG. 2, which shows a block diagram of a resistive touch panel 110. Resistive touch panel 110 includes resistive sensing panel 120, driving circuit 122, sensing circuit 124 and microcontroller 126. The operation principle of resistive touch panel 110 is: when an object contacts resistive sensing panel 120, an analog voltage level will be generated by resistive sensing panel 120 according to the contact position and sent to microcontroller 126. Microcontroller 126 would response properly according to such electrical signal so as to control the system status. Please refer to FIG. 3, which is a cross-sectional diagram of a conventional resistive touch display panel. The resistive touch panel includes a cover layer 150, a conductive film 152, spacers 154, conductive glass 156, substrate 158 and liquid crystal panel 160.

A conventional touch panel needs to be touched or contacted to initiate a touch control, e.g. on the touch panels of current small home appliances, the touch panels must be touched to operate the human-machine interface. To increase human-machine interactions and reduce the damages caused by actual touch motions, a new technology is needed to replace the touch panels that are relied on actual touch operations.

### SUMMARY OF THE INVENTION

Accordingly, the present invention provides a proximity-sensing panel. The proximity-sensing panel includes a substrate panel and proximity-sensing unit(s) disposed on the substrate panel. Such proximity-sensing panel generates a sensing signal without being actually touched. Product life cycle would be able to extend by reducing the frequency of actually touching the panel.

In an embodiment according to the present invention, a proximity-sensing panel includes a substrate panel, one or more proximity-sensing units and one or more sensing units. The proximity-sensing units are formed on the substrate panel. The proximity-sensing unit senses a motion of an object and generates a proximity-sensing signal. The sensing circuit electrically connects with the proximity-sensing unit to receive the proximity-sensing signal and generate a control signal accordingly to initiate a proximity control.

In another embodiment according to the present invention, a proximity-sensing panel includes a substrate panel, one or more mutual-capacitive proximity-sensing units and one or more sensing units. The mutual-capacitive proximity-sensing unit is formed on the substrate panel. The mutual-capacitive proximity-sensing unit senses a motion of an object and generates a proximity-sensing signal; wherein the shape of the mutual-capacitive proximity-sensing unit is selected from a group consisting of Concentric Circles, Arc Surrounding Circle, Concentric Rectangles and Concentric Rectangular Labyrinth. The sensing circuit electrically connects with the proximity-sensing unit to receive the proximity-sensing signal and generate a control signal accordingly to initiate a proximity control.

Preferred embodiments of the present invention and efficacies thereof will be illustrated in detail below with the accompanying drawings.

### BRIEF DESCRIPTION OF THE DRAWINGS

The present invention will become more fully understood from the detailed description given herein below for illustration only, and thus are not limitative of the present invention, and wherein:

FIG. 1 is a system block diagram according to an inductive proximity-sensing system in the conventional technology;

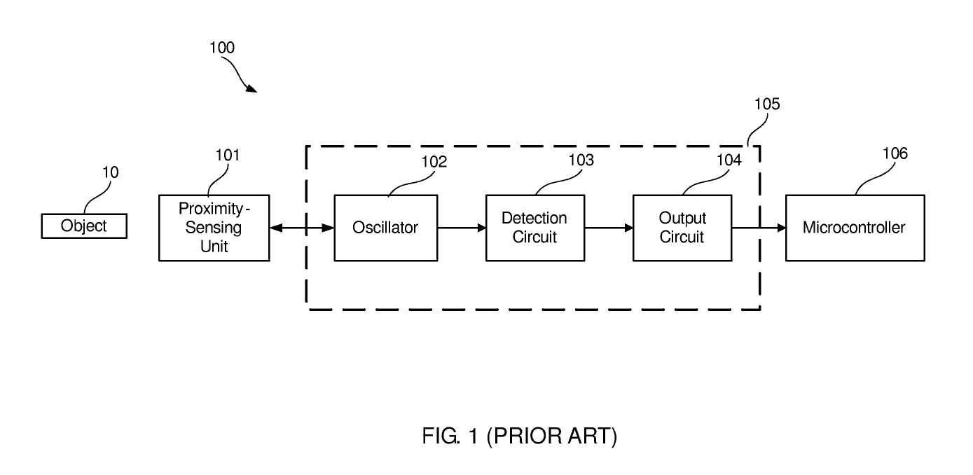

FIG. 2 is an explanatory diagram of a conventional resistive touch panel;

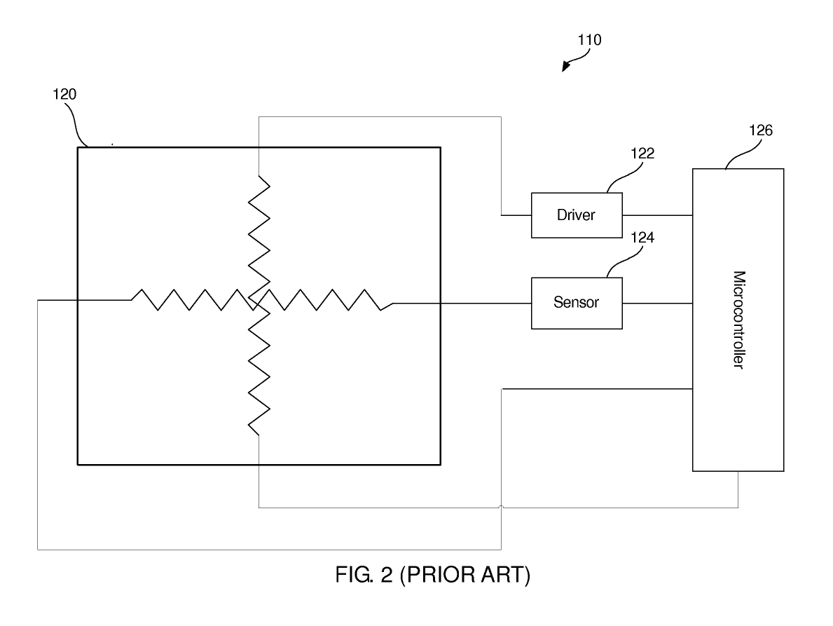

FIG. 3 is a cross-sectional diagram of a conventional resistive touch panel;

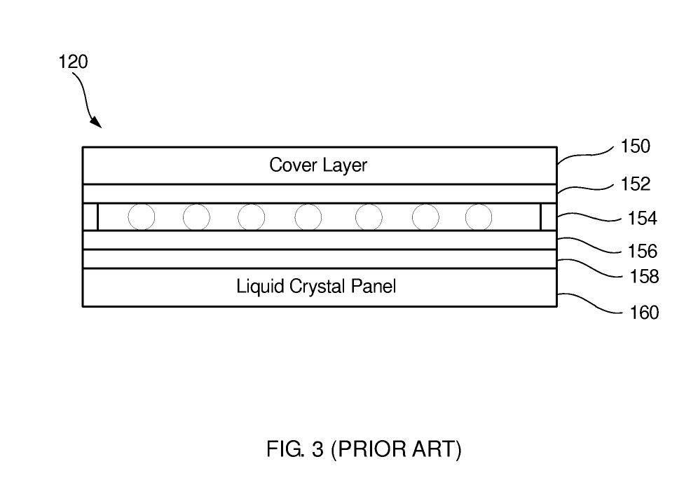

FIG. 4 is a system block diagram of a proximity-sensing panel according to an embodiment of the present invention;

FIG. 5 is a top view of a proximity-sensing panel according to another embodiment of the present invention;

FIG. 6 is a top view of a proximity-sensing panel according to another embodiment of the present invention;

FIG. 7 is a top view of a proximity-sensing panel according to another embodiment of the present invention;

FIG. 8 is a top view of a proximity-sensing panel according to another embodiment of the present invention;

FIG. 9 is a cross-sectional diagram of a proximity-sensing panel according to another embodiment of the present invention;

FIG. 10 is a top view of a proximity-sensing panel according to another embodiment of the present invention, illustrating the shapes of the proximity-sensing units on the proximity-sensing panel;

FIG. 11 is a top view of a proximity-sensing panel according to another embodiment of the present invention, illustrating the shapes of the proximity-sensing units on the proximity-sensing panel;

FIG. 12 is a system block diagram of a capacitive proximity-sensing panel according to another embodiment of the present invention;

FIG. 13 is a system block diagram of a capacitive proximity-sensing panel according to another embodiment of the present invention;

FIG. 14 is a system block diagram of a capacitive proximity-sensing panel according to another embodiment of the present invention; and

FIG. 15 is a system block diagram of a capacitive proximity-sensing panel according to another embodiment of the present invention.

### DETAILED DESCRIPTION OF THE INVENTION

Disclosed in the following embodiments of the present invention is mainly a proximity-sensing panel, which includes a substrate panel and at least one proximity-sensing unit. By forming the proximity-sensing unit onto various types of the substrate panel, the total manufacturing cost and the complexity of system cable routing are reduced. The applied substrate panel will have the function of proximity-sensing to achieve an enhanced human-machine interaction. The proximity-sensing unit is formed on the substrate panel during the original manufacturing processes of the substrate panel but without affecting those procedures treated on a functional area of the substrate panel, thereby greatly reducing the manufacturing costs of installing the proximity-sensing unit.

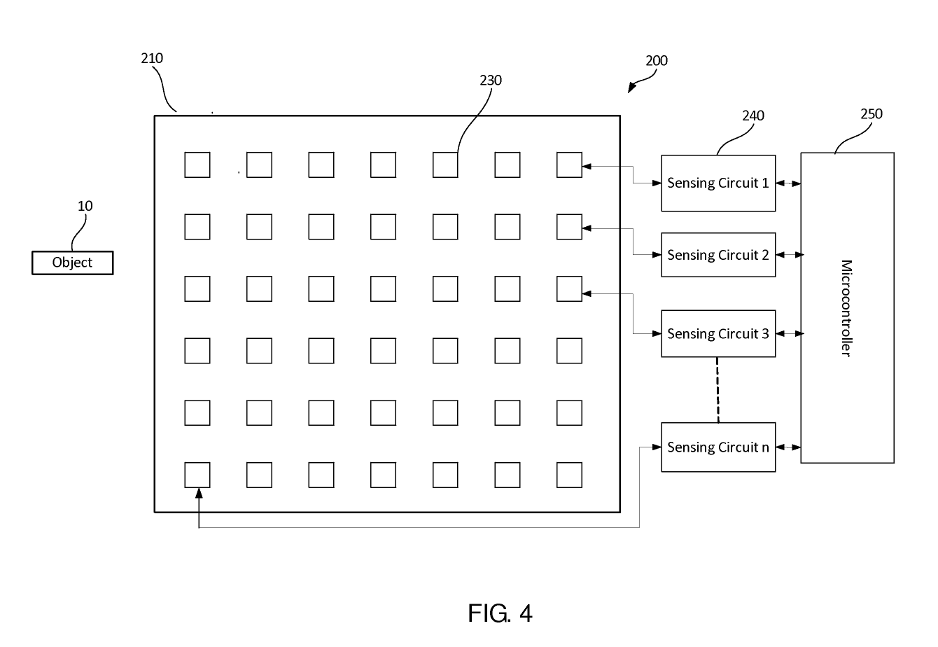

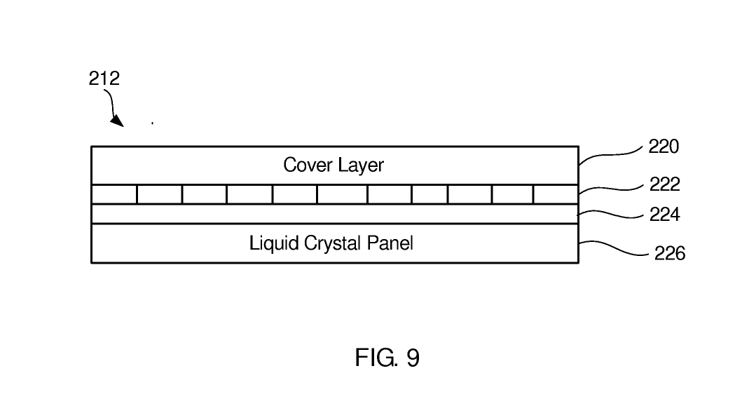

Refer to FIG. 4, which is a system block diagram of a proximity-sensing panel 200 according to an embodiment of the present invention. Proximity-sensing panel 200 includes panel 210 (panel 210 may include a display panel and a substrate panel, see FIG. 9), multiple proximity-sensing units 230 and multiple sensing circuit 240. Proximity-sensing units 230 are formed on a substrate panel (see substrate panel 224 in FIG. 9) and generate corresponding proximity sensing signals according to motions of object 10. The intensity of the proximity-sensing signal varies according to the distances of object 10. Sensing circuit 240 receives the proximity-sensing signal and generates a control signal to initiate a proximity control. The proximity control is similar to touch control on a touch screen yet without the fingers or the object actually touches the panel. Microcontroller 250 electrically connects with sensing circuit 240 to receive the control signal and generate coordinate data (X, Y) through calculation. Microcontroller 250 is able to determine the directions of gestures (motions of finger/object 10) according to the coordinate data (X,Y), such as left-to-right direction, right-to-left direction, oblique left-to-right direction, oblique right-to-left direction, top-to-bottom direction, bottom-to-top direction, two objects moving in opposite directions (enlarging) away from each other, two objects moving in opposite directions (enlarging) close to each other and etc. Thus, interactive gesture controls may be realized between the user and the panel 210.

In an embodiment of the present invention, proximity-sensing unit 230 may be realized by an inductive proximity-sensing unit that generates the sensing signals according to the changes of inductances. According to the embodiments of the present invention, the substrate panel may be realized by glass substrate panel, plastic substrate panel or color-filter substrate panel. A color-filter substrate panel is a substrate that allows a color filter to form thereon, commonly seen in a liquid crystal display. According to another embodiment of the present invention, the substrate panel may be realized by OLED panel.

The inductive proximity-sensing unit changes the intensity of the sensing signal based on the distance of the object. Namely, the intensity changes of the sensing signal indicates the changes of the inductances of the inductive proximity-sensing unit. An oscillator inside the sensing circuit 240 changes its oscillation frequency/amplitude according the changes of inductances; the control signal is generated according to the oscillation frequency/amplitude and is output to microcontroller 250.

In another embodiment of the present invention, proximity-sensing unit 230 may be realized by a capacitive proximity-sensing unit that generates the sensing signal according to the changes of capacitance. Here, the substrate panel may still be realized by glass substrate panel, plastic substrate panel or color-filter substrate panel. According to the embodiment, the substrate panel is basically a substrate of a display panel incapable of directly displaying an image. (On the contrary, a liquid crystal panel/layer is able to directly display an image under a backlight.) However, in another embodiment of the present invention, the substrate panel may be realized by OLED panel.

The capacitive proximity-sensing unit changes the intensity of the sensing signal according to the distances of the object. The intensity changes of the sensing signal indicates the changes of the capacitance in the capacitive proximity-sensing unit. An oscillator inside the sensing circuit 240 changes its oscillation frequency/amplitude according the changes of capacitances; the control signal is generated according to the oscillation frequency/amplitude and is output to microcontroller 250. Moreover, capacitive proximity-sensing unit may select from self-capacitance proximity-sensing unit and mutual-capacitance proximity-sensing unit. The self-capacitive proximity-sensing unit uses at least one electrode (single-electrode) to drive its touch sensing operation and sense the touch inputs. On the other hand, the mutual-capacitance proximity-sensing unit uses at least two electrodes (dual-electrode) to drive and sense.

According to embodiments of the present invention, the arranged pattern of proximity-sensing units on the proximity-sensing panel may be “rectangular arrangement”, “crisscross arrangement” or any other arranged patterns.

Furthermore, the proximity-sensing unit(s) may be selectively formed in a “displaying area” through which an image may be displayed by a display panel. Namely, in a projected three-dimensional space of the displaying area on the proximity-sensing panel, a proximity-sensing function may possibly be provided therein.

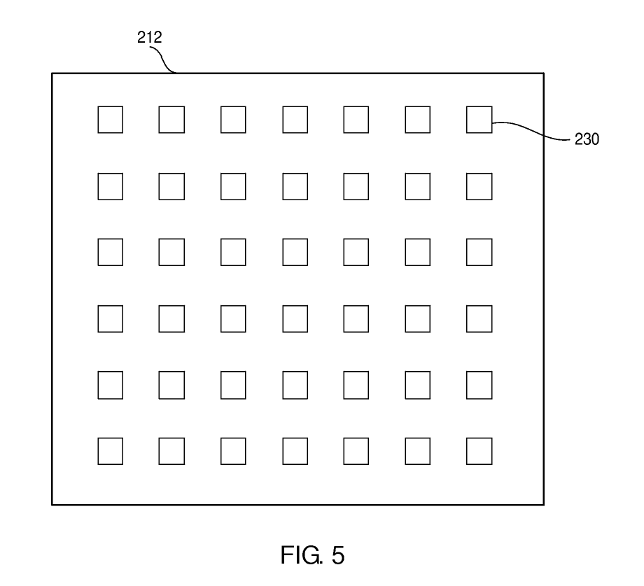

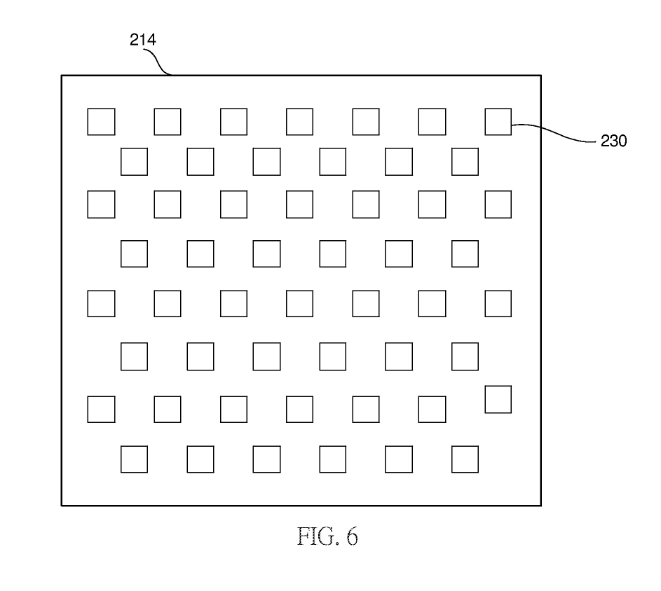

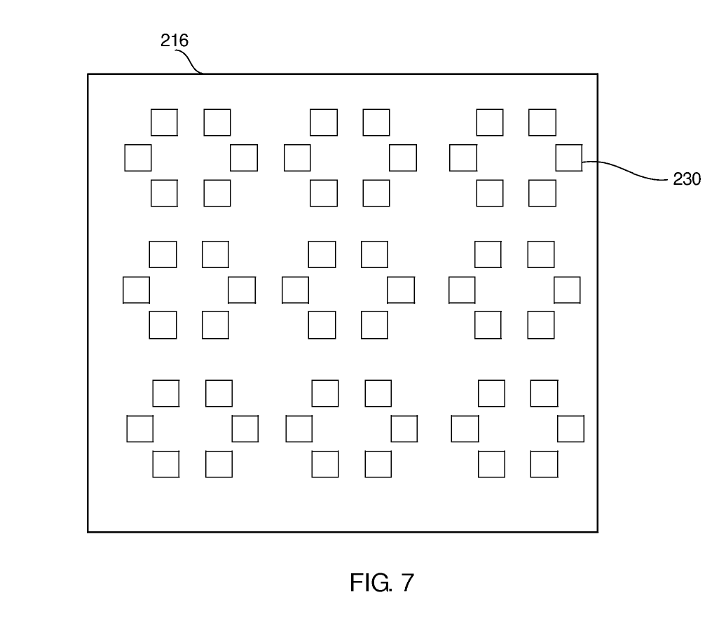

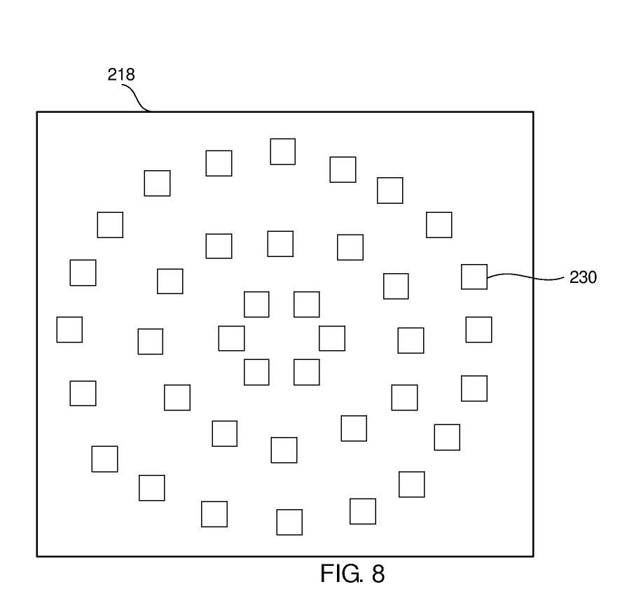

The following embodiments in FIG. 5, FIG. 6, FIG. 7 and FIG. 8, will illustrate four disposed patterns of the proximity-sensing units arranged on the proximity-sensing panel.

Please refer to FIG. 5, which illustrates a top view for arranged proximity-sensing units of a proximity-sensing panel according another embodiment of the present invention. As shown in the drawing, the proximity-sensing units 230 are disposed in a “rectangular arrangement” on the proximity-sensing panel 212 so that adjacent four proximity-sensing units 230 are able form a rectangle.

Please refer to FIG. 6, which illustrates another top view for arranged proximity-sensing units of a proximity-sensing panel according another embodiment of the present invention. Here the proximity-sensing units 230 of the proximity-sensing panel 214 are disposed in a “crisscross arrangement” so that adjacent four proximity-sensing units 230 forming a rectangle may have another one proximity-sensing unit 230 disposed in the center. A similar arrangement is “diamond arrangement” that includes four proximity-sensing units to form a diamond shape without an extra one disposed in the center.

Please refer to FIG. 7, which illustrates another top view for arranged proximity-sensing units of a proximity-sensing panel according another embodiment of the present invention. Here the proximity-sensing units 230 of the proximity-sensing panel 216 are disposed in a “hexagon arrangement” so that adjacent six proximity-sensing units 230 are able form a hexagon.

Please refer to FIG. 8, which illustrates another top view for arranged proximity-sensing units of a proximity-sensing panel according another embodiment of the present invention. Here the proximity-sensing units 230 of the proximity-sensing panel 218 are disposed in a “concentric-circles arrangement” so that the proximity-sensing units 230 are able form two or more circles with the same center. A similar arrangement is “circular arrangement” in which only one circle is formed by the arranged proximity-sensing units.

FIG. 9 shows a cross-sectional diagram of another proximity-sensing panel according to another embodiment of the present invention. Proximity-sensing panel 212 mainly includes a cover layer 220, proximity-sensing unit 222, substrate panel 224 and liquid crystal panel 226. Since at least an electrode layer may be formed on substrate panel 224, proximity-sensing units 140 may be selectively formed on the top surface or the bottom surface of the substrate panel 224, or both the top and bottom surfaces.

The shapes of the proximity-sensing unit itself may be selected from circle, rectangle, eclipse, H-shape, concentric rectangles, diamond, spiral or any other shapes.

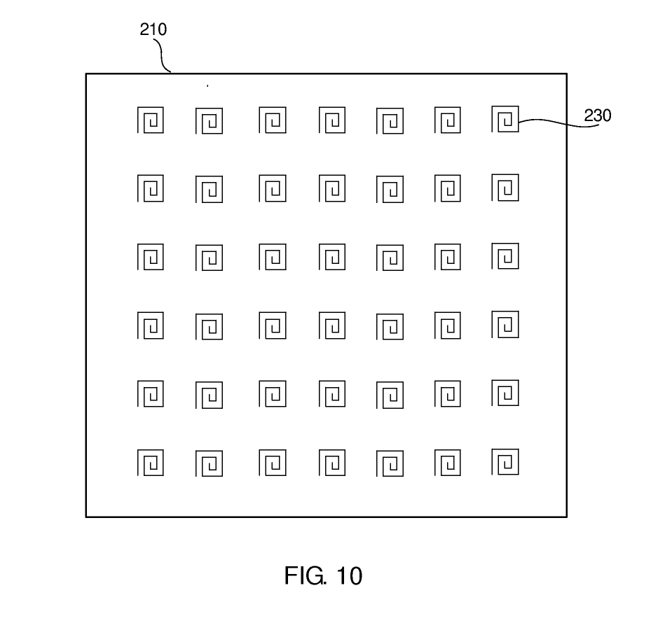

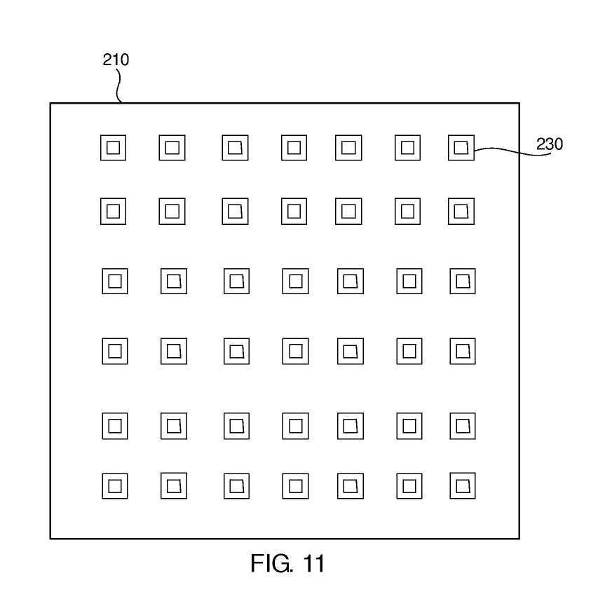

FIG. 10 and FIG. 11 illustrate proximity-sensing units with two different shapes formed on the substrate panel. In FIG. 10, the illustrated proximity-sensing unit is spiral and in FIG. 11 the proximity-sensing unit is concentric rectangular.

In an embodiment, at least a mutual-capacitive proximity-sensing unit is formed on the substrate panel 260. The mutual-capacitive proximity-sensing unit senses an approaching operation of an object and generates a proximity-sensing signal; wherein the shape of the mutual-capacitive proximity-sensing unit is selected from a group consisting of Concentric Circles, Arc Surrounding Circle, Concentric Rectangles and Concentric Rectangular Labyrinth.

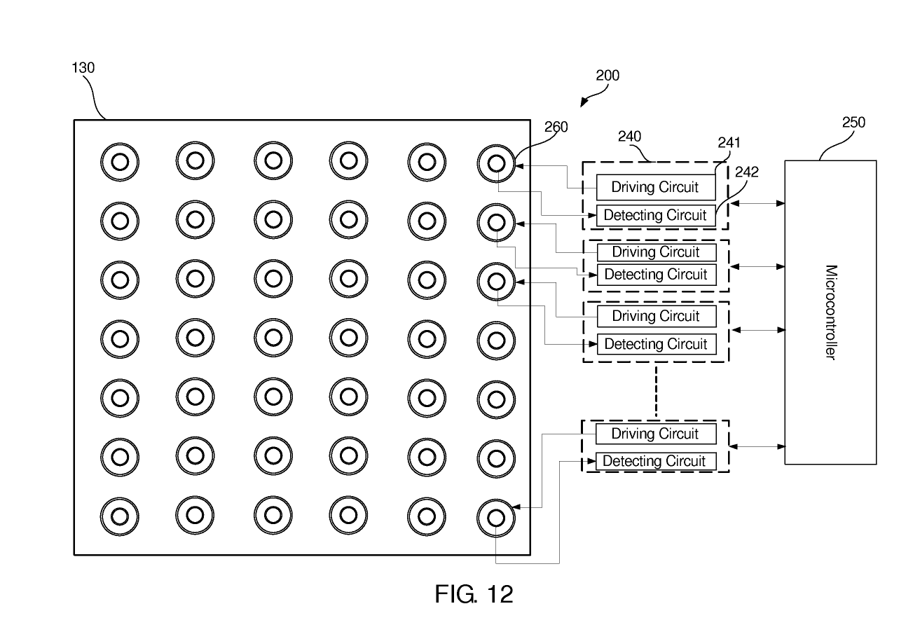

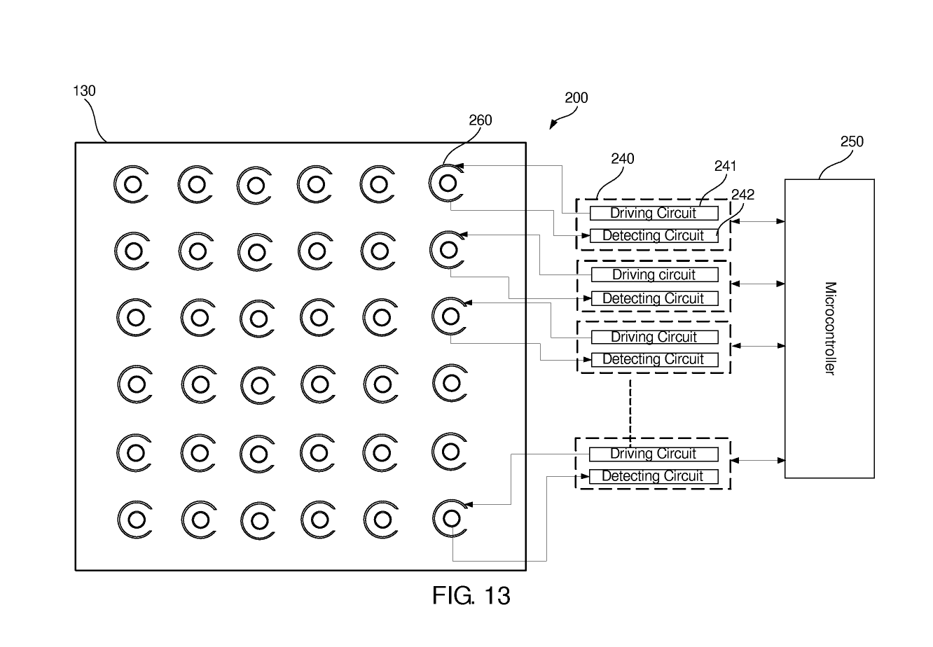

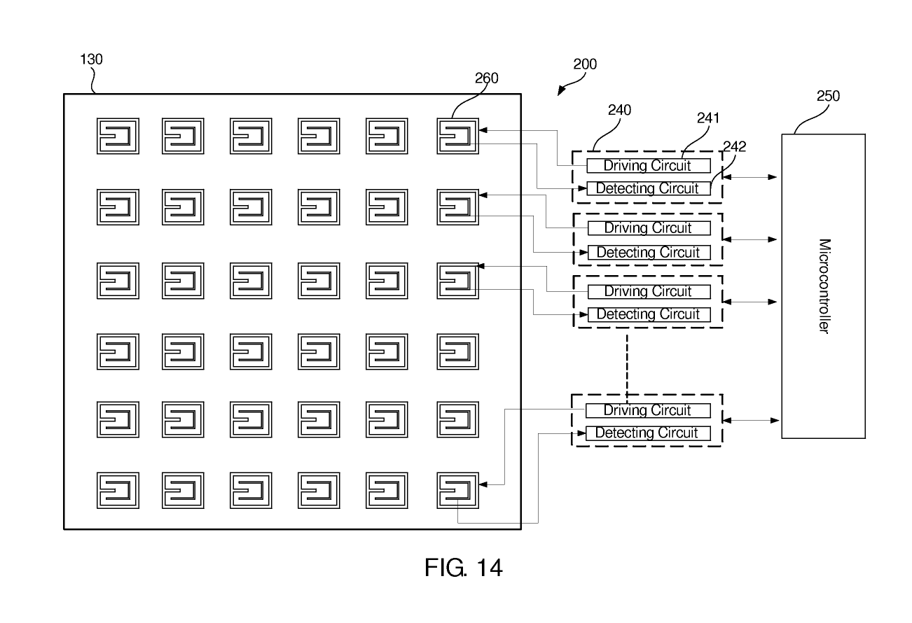

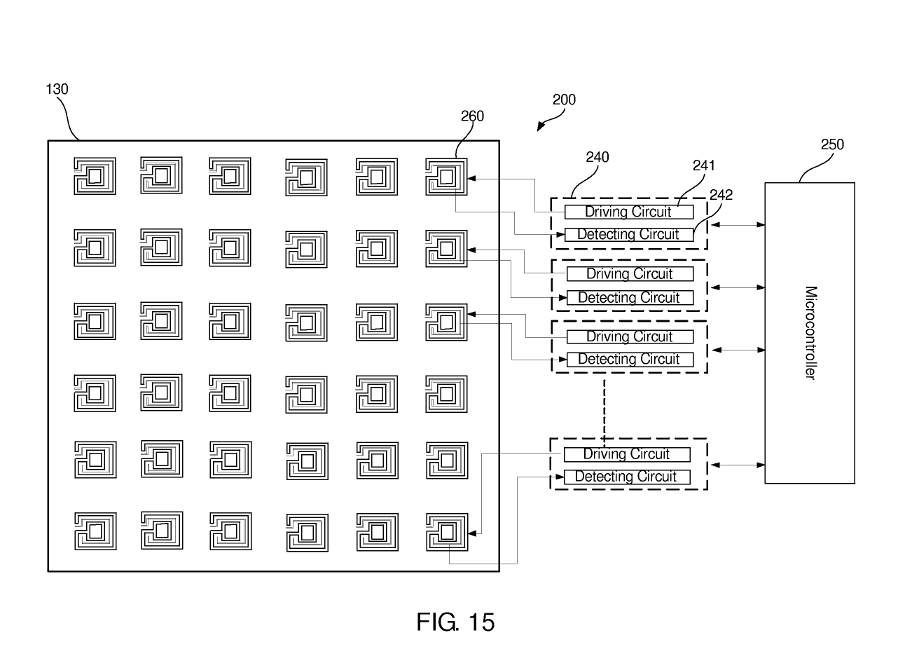

In FIG. 12, the shape of the two electrodes of the mutual-capacitance proximity-sensing unit 260 is defined as “Concentric Circles” with two circle electrodes having the same center. In FIG. 13, the shape of the two electrodes of the mutual-capacitance proximity-sensing unit 260 is defined as “Arc Surrounding Circle”, in which an arc electrode surrounds a smaller circle electrode. FIG. 14, the shape of the two electrodes of the mutual-capacitance proximity-sensing unit 260 is defined as “Concentric Rectangles”, in which a rectangular electrode with an end extended inwards surrounds an U-shaped electrode; wherein the extended end of the rectangular electrode points out a direction towards an opening of the U-shaped electrode. In FIG. 15, the shape of the two electrodes of the mutual-capacitance proximity-sensing unit 260 is defined as “Concentric Rectangular Labyrinth”; wherein an electrode routes along an opened outer rectangle with a closed inner rectangle surrounded inside the opened rectangle, and the other electrode routes along the gap between the outer and inner rectangles.

The application circuits shown in FIG. 12, FIG. 13, FIG. 14 and FIG. 15 will be further explained hereinafter. Each of mutual-capacitive proximity-sensing units includes two electrodes; one electrode connects to driving circuit 241 and the other electrode connects to detecting circuit 242. The principle of using mutual-capacitive proximity-sensing units 220 to sense motions of object 10 is as follows. Sensing circuit 241 drives a signal to the connected first electrode and then the other electrode (second electrode) generates corresponding mutual capacitance. When object 10 moves toward or away from proximity-sensing units 230, the capacitance of proximity-sensing units 230 will be affected. In the meantime, detecting circuit 242 detects the capacitance changes through the connected second electrode, and obtains the capacitance changes of proximity-sensing units 230 through the changes of voltage or current in the detecting circuit 242. Thus, the relative distance between object 10 and the panel is able to be calculated. By means of mutual-capacitive proximity-sensing units, the proximity-sensing display panel is able to respond faster and operate stably.

While the present invention has been described by the way of example and in terms of the preferred embodiments, it is to be understood that the invention need not to be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A proximity-sensing panel, comprising:
a substrate panel;
a plurality of proximity-sensing units, formed on the substrate panel, the proximity-sensing unit sensing a motion of an object and generating a proximity-sensing signal; and
at least one sensing circuit, electrically connecting the proximity-sensing unit to receive the proximity-sensing signal and generating a control signal accordingly to initiate a proximity control.

2. The proximity-sensing panel of claim 1, wherein the proximity-sensing unit is selected from the group consisting of a capacitive proximity-sensing unit and an inductive proximity-sensing unit.

3. The proximity-sensing panel of claim 2, wherein the capacitive proximity-sensing unit is selected from the group consisting of a self-capacitance proximity-sensing unit and a mutual-capacitance proximity-sensing unit.

4. The proximity-sensing panel of claim 3, wherein the mutual-capacitance proximity-sensing unit comprises at least two electrodes.

5. The proximity-sensing panel of claim 1, wherein the substrate panel is selected from the group consisting of OLED (Organic Light-Emitting Diode) panel, glass substrate panel, plastic substrate panel and color-filter substrate panel.

6. The proximity-sensing panel of claim 1, wherein the substrate panel is formed adjacent to a liquid crystal panel.

7. The proximity-sensing panel of claim 1, wherein the shape of the proximity-sensing unit is selected from the group consisting of circle, rectangle, eclipse, H-shape, concentric rectangles, diamond and spiral.

8. The proximity-sensing panel of claim 1, wherein the proximity-sensing units are formed on a top surface of the substrate panel, on a bottom surface of the substrate panel, or both the top and bottom surfaces of the substrate panel.

9. The proximity-sensing panel of claim 1, wherein an arranged pattern of the proximity-sensing units formed on the substrate panel is selected from the group consisting of rectangular arrangement, crisscross arrangement, concentric-circles arrangement, hexagon arrangement, circular arrangement and hexagon arrangement.

10. A proximity-sensing panel, comprising:
a substrate panel;
at least a mutual-capacitive proximity-sensing unit, formed on the substrate panel, the mutual-capacitive proximity-sensing unit sensing a motion of an object and generating a proximity-sensing signal, wherein the shape of the mutual-capacitive proximity-sensing unit is selected from a group consisting of Concentric Circles, Arc Surrounding Circle, Concentric Rectangles and Concentric Rectangular Labyrinth; and
at least one sensing circuit, electrically connecting the proximity-sensing unit to receive the proximity-sensing signal and generating a control signal accordingly to initiate a proximity control.

11. The proximity-sensing panel of claim 10, wherein the mutual-capacitance proximity-sensing unit comprises at least two electrodes.

12. The proximity-sensing panel of claim 10, wherein the substrate panel is selected from the group consisting of OLED (Organic Light-Emitting Diode) panel, glass substrate panel, plastic substrate panel and color-filter substrate panel.

13. The proximity-sensing panel of claim 10, wherein the substrate panel is formed adjacent to a liquid crystal panel.

14. The proximity-sensing panel of claim 10, wherein an arranged pattern of the proximity-sensing units formed on the substrate panel is selected from the group consisting of rectangular arrangement, crisscross arrangement, concentric-circles arrangement, hexagon arrangement, circular arrangement and hexagon arrangement.

15. The proximity-sensing panel of claim 10, wherein the shape of the proximity-sensing unit is selected from the group consisting of circle, rectangle, eclipse, H-shape, concentric rectangles, diamond and spiral.

16. The proximity-sensing panel of claim 10, wherein the proximity-sensing units are formed on a top surface of the substrate panel, on a bottom surface of the substrate panel, or both the top and bottom surfaces of the substrate panel.

17. The proximity-sensing panel of claim 10, wherein the Concentric Circles is formed by two circle electrodes having the same center.

18. The proximity-sensing panel of claim 10, wherein the Arc Surrounding Circle is formed by an arc electrode surrounds a smaller circle electrode.

19. The proximity-sensing panel of claim 10, wherein the Concentric Rectangles is formed by a rectangular electrode with an end extended inwards surrounding an U-shaped electrode; wherein the extended end of the rectangular electrode points out a direction towards an opening of the U-shaped electrode.

20. The proximity-sensing panel of claim 10, wherein the Concentric Rectangular Labyrinth is formed by an electrode routing along an opened outer rectangle with a closed inner rectangle surrounded inside the opened rectangle, and the other electrode routes along the gap between the outer and inner rectangles.
